(19) United States
(12) Patent Application Publication
(10) Pub. No.: US 2003/0093570 A1
(43) Pub. Date: May 15, 2003

(54) Fault tolerant processing

(76) Inventor: Thomas D. Bissett, Groton, MA (US)

Correspondence Address: FISH & RICHARDSON P.C., 1425 K STREET, N.W., 11TH FLOOR, WASHINGTON, DC, 20005-3500, US

(21) Appl. No.: 10/178,894

(22) Filed: Jun. 25, 2002

Related U.S. Application Data
(60) Provisional application No. 60/300,090, filed on Jun. 25, 2001.

(51) Int. Cl. G06F 15/16

(52) U.S. Cl. 709/248

(57) ABSTRACT

Operation of two asynchronous processors are synchronized with an I/O device by receiving, at a first processor having a first clocking system, data from an I/O device. The data is received at a first time associated with the first clocking system, and is forwarded from the first processor to a second processor having a second clocking system that is not synchronized with the first clocking system. The data is processed at the first processor at a second time corresponding to the first time in the first clocking system plus a time offset, and at the second processor at a third time corresponding to the first time in the second clocking system plus the time offset.

### CROSS-REFERENCE TO RELATED APPLICATIONS

This application claims priority from U.S. Provisional Application No. 60/300,090, titled “InfiniBand Fault Tolerant Processor” and filed Jun. 25, 2001, which is incorporated by reference.

### TECHNICAL FIELD

This description relates to fault-tolerant processing systems and, more particularly, to techniques for synchronizing single and multi-processing systems in which processors that use independent and non-synchronized clocks are mutually connected to one or more I/O subsystems.

### BACKGROUND

Fault-tolerant systems are used for processing data and controlling systems when the cost of a failure is unacceptable. Fault-tolerant systems are used because they are able to withstand any single point of failure and still perform their intended functions.

There are several architectures for fault-tolerant systems. For example, a checkpoint/restart system takes snapshots (checkpoints) of the applications as they run and generates a journal file that tracks the input stream. When a fault is detected in a subsystem, the faulted subsystem is removed from the system, the applications are restarted from the last checkpoint, and the journal file is used to recreate the input stream. Once the journal file has been reprocessed by the application, the system has recovered from the failure. A checkpoint/restart system requires cooperation between the application and the operating system, and both generally need to be customized for this mode of operation. In addition, the time required for such a system to recover from a failure generally depends upon the frequency at which the checkpoints are generated.

Another primary type of fault-tolerant system design employs redundant processors, all of which run applications simultaneously. When a fault is detected in a subsystem, the faulted subsystem is removed and processing continues. When a faulted processor is removed, there is no need to back up and recover since the application was running simultaneously on another processor. The level of synchronization between the redundant processors varies with the architecture of the system. The redundant processing sites must be synchronized to within a known time skew in order to detect a fault at one of the processing sites. This time skew becomes an upper bound on both the error detection time and on the I/O response time of the system.

A hardware approach uses tight synchronization in which the clocks of the redundant processors are deterministically related to each other. This may be done using either a common oscillator system or a collection of phase-locked clocks. In this type of system, all processors get the same clock structure. Access to an asynchronous I/O subsystem can be provided through a simple synchronizer the buffers communications with the I/O subsystem. All processors see the same I/O activity on the same clock cycle. System synchronization is maintained tightly enough that every I/O bus cycle can be compared on a clock-by-clock basis. Time skew between the redundant processors is less than one I/O clock cycle. An advantage of this system is that fault-tolerance can be provided as an attribute to the system without requiring customization of the operating system and the applications. Additionally, error detection and recovery times are reduced to a minimum, because the worst-case timeout for a failed processor is less than a microsecond. A disadvantage is that the processing modules and system interconnect must be carefully crafted to preserve the clocking structure.

A looser synchronization structure allows clocks of the redundant processors to be independent but controls the execution of applications to synchronize the processors each time that a quantum of instructions is executed. I/O operations are handled at the class driver level. Comparison between the processors is done at an I/O request and data packets level. All I/O data is buffered before it is presented to the redundant processors. This buffering allows an arbitrarily large time skew (distance) between redundant processors at the expense of system response. In these systems, industry-standard motherboards are used for the redundant processors. Fault-tolerance is maintained as an attribute with these systems, allowing unmodified applications and operating systems to be used.

### SUMMARY

In one general aspect, synchronizing operation of two asynchronous processors with an I/O device includes receiving, at a first processor having a first clocking system, data from an I/O device. The data is received at a first time associated with the first clocking system, and is forwarded from the first processor to a second processor having a second clocking system that is not synchronized with the first clocking system. The data is processed at the first processor at a second time corresponding to the first time in the first clocking system plus a time offset, and at the second processor at a third time corresponding to the first time in the second clocking system plus the time offset.

Implementations may include one or more of the following features. For example, the received data may be stored at the first processor during a period between the first time and the second time, and at the second processor between a time at which the forwarded data is received and the third time. The data may be stored at the first processor comprises in a first FIFO associated with the first processor and at the second processor comprises in a second FIFO associated with the second processor.

The data may be forwarded using a direct link between the first processor and the second processor. The time offset may correspond to a time required for transmission of data from the first processor to the second processor using the direct link plus a permitted difference in clocks of the first clocking system and the second clocking system.

The I/O device may include a third clocking system that is not synchronized with the first clocking system or the second clocking system. The I/O device may be an industry standard I/O device, and the first processor may be connected to the I/O device by an industry-standard network interconnect, such as Ethernet or InfiniBand. The I/O device may be shared with another system, such as another fault-tolerant system, that does not include the first processor or the second processor, as may be at least a portion of the connection between the first processor and the I/O device.

Other features will be apparent from the following description, including the drawings, and the claims.

### DESCRIPTION OF THE DRAWINGS

FIGS. 1-3 are block diagrams of fault-tolerant systems.

FIG. 4 is a block diagram of a redundant CPU module of the system of FIG. 3.

FIGS. 5 and 6 are block diagrams of data flow paths in the redundant CPU module of FIG. 4.

FIGS. 7, 8A and 8B are block diagrams of a computer system.

### DETAILED DESCRIPTION

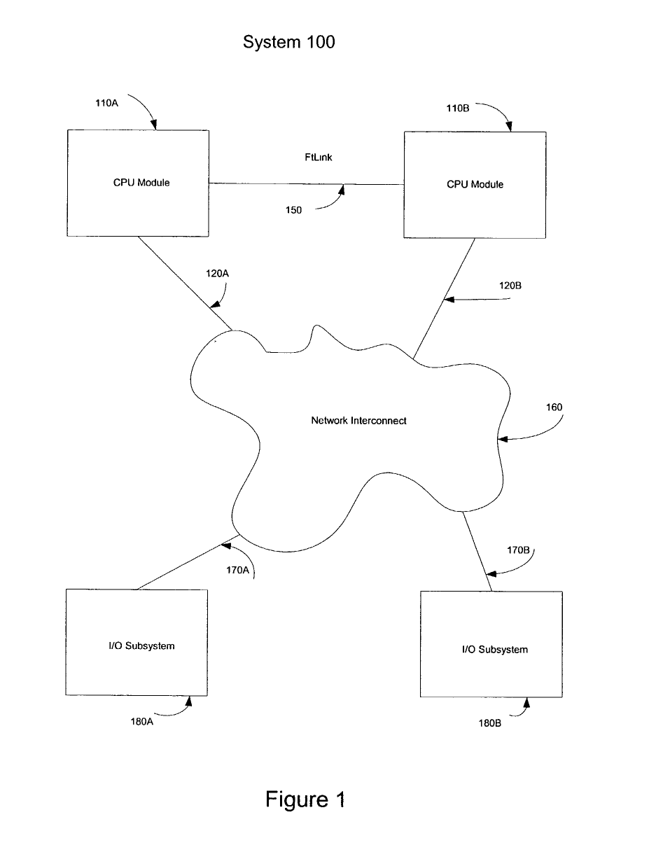

FIG. 1 shows a fault-tolerant system 100 made from two industry-standard CPU modules 110A and 110B. System 100 provides a mechanism for constructing fault-tolerant systems using industry-standard I/O subsystems. A form of industry-standard network interconnect 160 is used to attach the CPU modules to the I/O subsystems. For example, the standard network can be Ethernet or InfiniBand. System 100 provides redundant processing and I/O and is therefore considered to be a fault-tolerant system. In addition, the network interconnect 160 provides sufficient connections between the CPU modules 110A and 110B and the I/O subsystems (180A and 180B) to prevent any single point of failure from disabling the system. CPU module 110A connects to network interconnect 160 through connection 120A. Access to I/O subsystem 180A is provided by connection 170A from network interconnect 160. Similarly, access to I/O subsystem 180B is provided by connection 170B from network interconnect 160. CPU module 110B accesses network interconnect 160 through connection 120B and thus also has access to I/O subsystems 180A and 180B. Ftlink 150 provides a connection between CPU modules 110A and 110B to allow either CPU module to use the other CPU module's connection to the network interconnect 160.

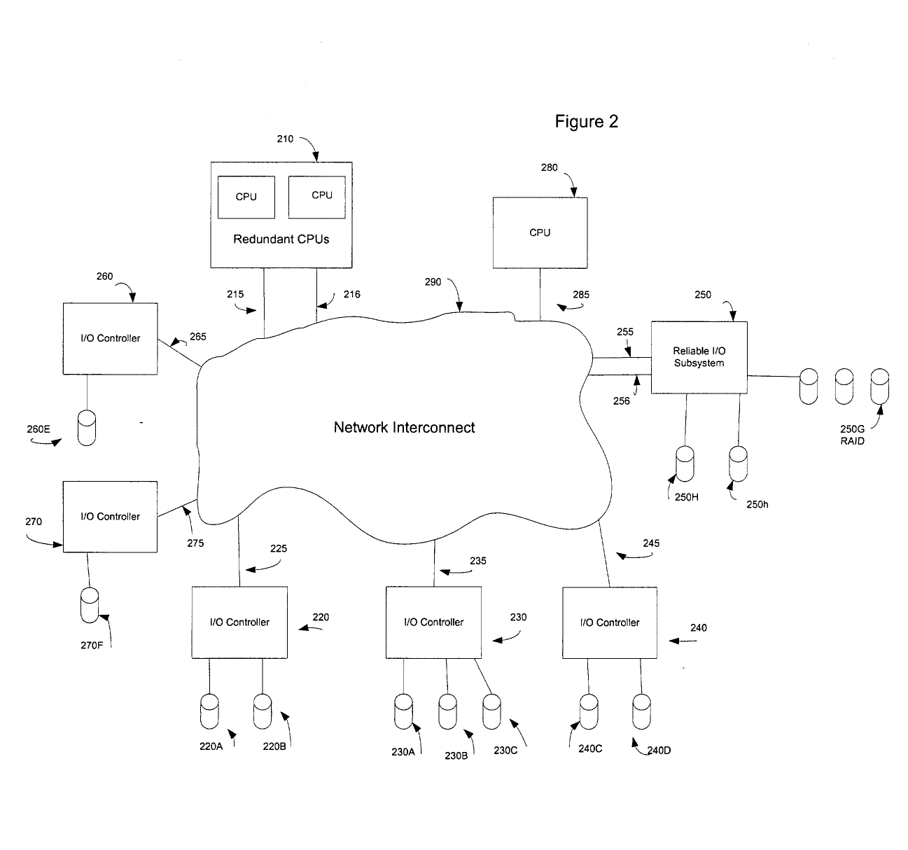

FIG. 2 illustrates an industry-standard network 200 that contains more than just a fault-tolerant system. The network is held together by network interconnect 290, which contains various repeaters, switches, and routers. In this example, CPU 280, connection 285, I/O controller 270, connection 275, and disk 270F embody a non-fault-tolerant system that use network interconnect 290. In addition, CPU 280 shares an I/O controller 240 and connection 245 with the fault-tolerant system in order to gain access to disk 240D.

The rest of system 200 embodies the fault-tolerant system. In particular, redundant CPU modules 210 are connected to network interconnect 290 by connections 215 and 216. I/O controller 220 provides access to disks 220A and 220B through connection 225. I/O controller 230 provides access to disks 230A and 230B, which are redundant to disks 220A and 220B, through connection 235. I/O controller 240 provides access to disk 240C, which is redundant to disk 230C of I/O controller 230, through connection 245. I/O controller 260 provides access to disk 260E, which is a single-ended device (no redundant device exists because the resource is not critical to the operation of the fault-tolerant system), through connection 265. Reliable I/O subsystem 250 provides, in this example, access to a RAID (redundant array of inexpensive disks) set 250G, and redundant disks 250H and 250h, through its redundant connections 255 and 256.

FIG. 2 demonstrates a number of characteristics of fault-tolerant systems. For example, disks are replicated (e.g., disks 220A and 230A are copies of each other). This replication is called host-based shadowing when the software in the CPU module 210 (the host) controls the replication. By contrast, the controller controls the replication in controller-based shadowing.

In host-based shadowing, explicit directions on how to create disk 220A are given to I/O controller 220. A separate but equivalent set of directions on how to create disk 230A are given to I/O controller 230.

Disk set 250H and 250h may be managed by the CPU (host-based shadowing), or I/O subsystem 250 may manage the entire process without any CPU intervention (controller-based shadowing). Disk set 250G is maintained by I/O subsystem 250 without explicit directions from the CPU and is an example of controller-based shadowing. I/O controllers 220 and 230 can cooperate to produce controller-based shadowing if either a broadcast or promiscuous mode allows both controllers to receive the same command set from the CPU module 210 or if the I/O controllers retransmit their commands to each other. In essence, this arrangement produces a reliable I/O subsystem out of non-reliable parts.

Devices in a fault-tolerant system are handled in a number of different ways. A single-ended device is one for which there is no recovery in the event of a failure. A single-ended device is not considered a critical part of the system and it usually will take operator intervention or repair action to complete an interrupted task that was being performed by the device. A floppy disk is an example of a single-ended device. Failure during reading or writing the floppy is not recoverable. The operation will have to be restarted through use of either another floppy device or the same floppy drive after it has been repaired.

A disk is an example of a redundant device. Multiple copies of each disk may be maintained by the system. When one disk fails, one of its copies (or shadows) is used instead without any interruption in the task being performed.

Other devices are redundant but require software assistance to recover from a failure. An example is an Ethernet connection. Multiple connections are provided, such as, for example, connections 215 and 216. Usually, one connection is active, with the other being in a stand-by mode. When the active connection fails, the connection in stand-by mode becomes active. Any communication that is in transit must be recovered. Since Ethernet is considered an unreliable medium, the standard software stack is set up to re-order packets, retry corrupted or missing packets, and discard duplicate packets. When the failure of connection 215 is detected by a fault-tolerant system, connection 216 is used instead. The standard software stack will complete the recovery by automatically retrying that portion of the traffic that was lost when connection 215 failed. The recovery that is specific to fault-tolerance is the knowledge that connection 216 is an alternative to connection 215.

InfiniBand is not as straightforward to use as Ethernet. The Ethernet hardware is stateless in that the Ethernet adaptor has no knowledge of state information related to the flow of packets. All state knowledge is contained in the software stack. InfiniBand host adaptors, by contrast, have knowledge of the packet sequence. The intent of InfiniBand was to design a reliable network. Unfortunately, the reliability does not cover all possible types of connections nor does it include recovery from failures at the edges of the network (the source and destination of the communications). In order to provide reliable InfiniBand communications, a software stack may be added to permit recovery from the loss of state knowledge contained in the InfiniBand host adaptors.

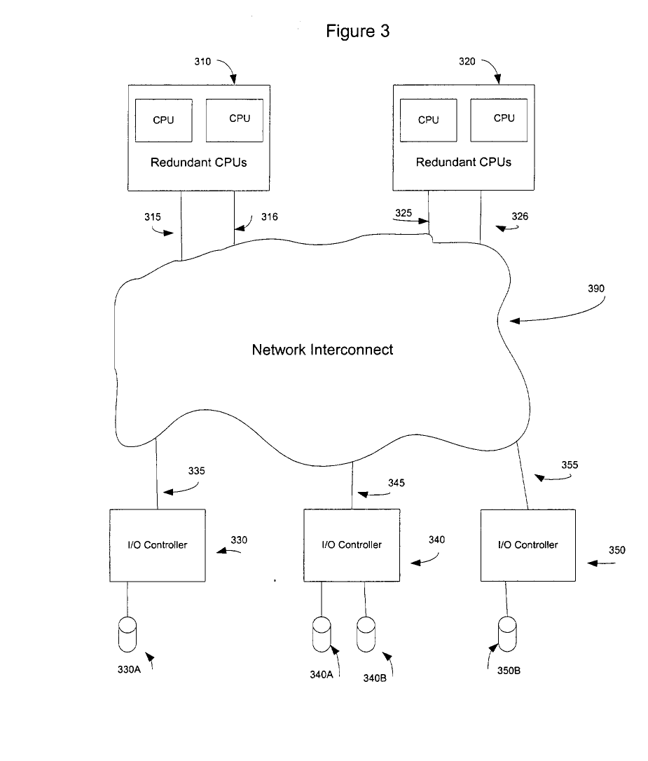

FIG. 3 shows several fault-tolerant systems that share a common network interconnect. A first fault-tolerant system is represented by redundant CPU module 310, which is connected to network interconnect 390 through connections 315 and 316. I/O controller 330 provides access to disk 330A through connection 335. I/O controller 340 provides access to disk 340A, which is redundant to disk 330A, through connection 345.

A second fault-tolerant system is represented by redundant CPU module 320, which is connected to network interconnect 390 through connections 325 and 326. I/O controller 340 provides access to disk 340B through connection 345. I/O controller 350 provides access to disk 350B, which is redundant to disk 340B, through connection 355.

I/O controller 340 is shared by both fault-tolerant systems. The level of sharing can be at any level depending upon the software structure that is put in place. In a peer-to-peer network, it is common practice to share disk volumes down to the file level. This same practice can be implemented with fault-tolerant systems.

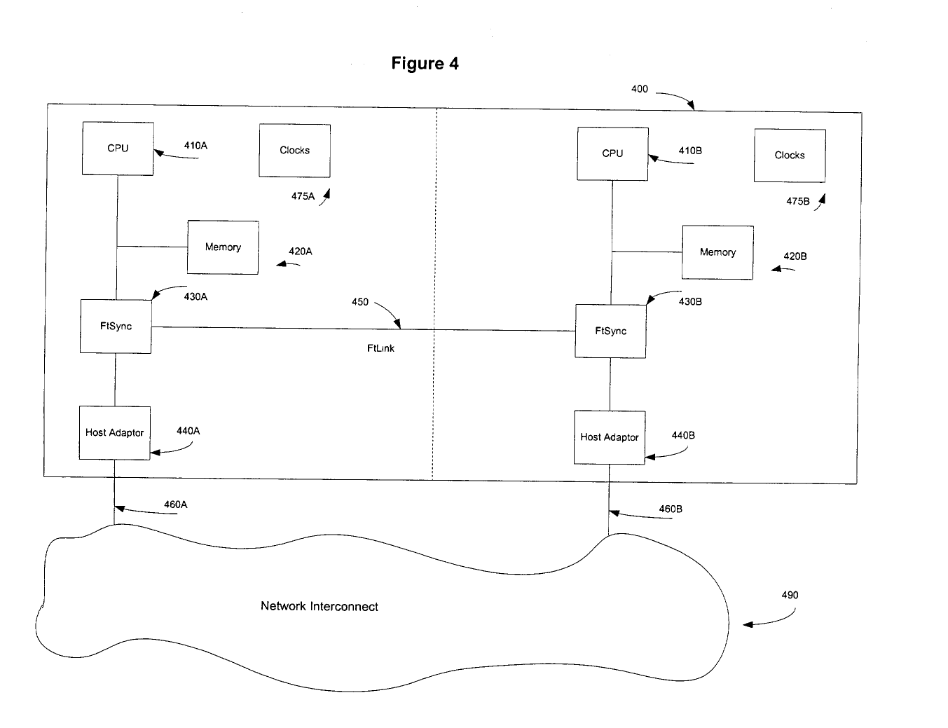

FIG. 4 illustrates a redundant CPU module 400 that may be used to implement the redundant CPU module 310 or the redundant CPU module 320 of the system 300 of FIG. 3. Each CPU module of the redundant CPU module is shown in a greatly simplified manner to emphasize the features that are particularly important for fault tolerance. Each CPU module has two external connections: Ftlink 450, which extends between the two CPU modules, and network connection 460A or 460B. Network connections 460A and 460B provide the connections between the CPU modules and the rest of the computer system. Ftlink 450 provides communications between the CPU modules for use in maintaining fault-tolerant operation. Connections to Ftlink 450 are provided by fault-tolerant sync (Ftsync) modules 430A and 430B, each of which is part of one of the CPU modules.

The system 400 is booted by designating CPU 410A, for example, as the boot CPU and designating CPU 410B, for example, as the syncing CPU. CPU 410A requests disk sectors from Ftsync module 430A. Since only one CPU module is active, Ftsync module 430A passes all requests on to its own host adaptor 440A. Host adaptor 440A sends the disk request through connection 460A into the network interconnect 490. The designated boot disk responds back through network interconnect 490 with the requested disk data. Network connection 460A provides the data to host adaptor 440A. Host adaptor 440A provides the data to Ftsync module 430A, which provides the data to memory 420A and CPU 410A. Through repetition of this process, the operating system is booted on CPU 410A.

CPU 410A and CPU 410B establish communication with each other through registers in their respective Ftsync modules and through network interconnect 490 using host adaptors 440A and 440B. If neither path is available, then CPU 410B will not be allowed to join the system. CPU 410B, which is designated as the sync slave CPU, sets its Ftsync module 430B to slave mode and halts. CPU 410A, which is designated as the sync master CPU, sets its Ftsync module 430A to master mode, which means that any data being transferred by DMA (direct memory access) from host adaptor 440A to memory 420A is copied over Ftlink 450 to the slave Ftsync module 430B. The slave Ftsync module 430B transfers that data to memory 420B. Additionally, the entire contents of memory 420A are copied through Ftsync module 430A, Ftlink 450, and Ftsync module 430B to memory 420B. Memory ordering is maintained by Ftsync module 430A such that the write sequence at memory 420B produces a replica of memory 420A. At the termination of the memory copy, I/O is suspended, CPU context is flushed to memory, and the memory-based CPU context is copied to memory 420B using Ftsync module 430A, Ftlink 450, and Ftsync module 430B.

CPUs 410A and 410B both begin execution from the same memory-resident instruction stream. Both CPUs are now executing the same instruction stream from their respective one of memories 420A and 420B. Ftsync modules 430A and 430B are set into duplex mode. In duplex mode, CPUs 410A and 410B both have access to the same host adaptor 440A using the same addressing. For example, host adaptor 440A would appear to be device 3 on PCI bus 2 to both CPU 410A and CPU 410B. Additionally, host adaptor 440B would appear to be device 3 on PCI bus 3 to both CPU 410A and CPU 410B. The address mapping is performed using registers in the Ftsync modules 430A and 430B.

Fault-tolerant operation is now possible. Ftsync modules 430A and 430B are responsible for aligning and comparing operations between CPUs 410A and 410B. An identical write access to host adaptor 440A originates from both CPU 410A and CPU 410B. Each CPU module operates on its own clock system, with CPU 410A using clock system 475A and CPU 410B using clock system 475B. Since both CPUs are executing the same instruction stream from their respective memories, and are receiving the same input stream, their output streams will also be the same. The actual delivery times may be different because of the local clock systems, but the delivery times relative to the clock structures 475A or 475B of the CPUs are identical.

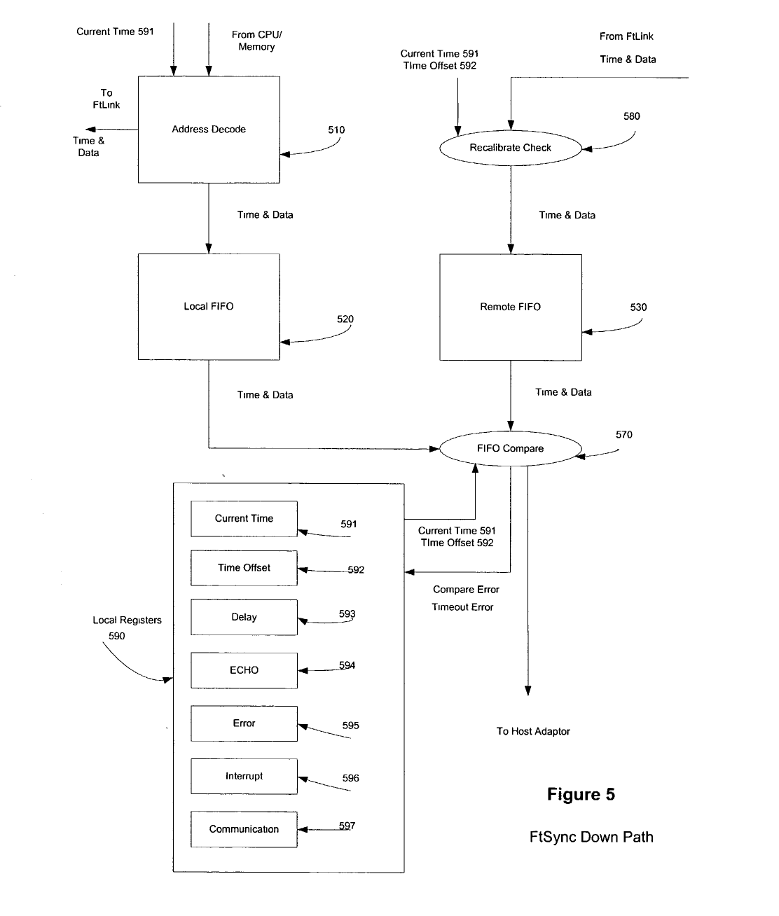

Referring also to FIG. 5, Ftsync module 430A checks the address of an access to host adaptor 450A with address decode 510 and appends the current time 591 to the access. Since it is a local access, the request is buffered in FIFO 520. Ftsync module 430B similarly checks the address of the access to host adaptor 440A with address decode 510 and appends its current time 591 to the access. Since the address is remote, the access is forwarded to Ftlink 450. Ftsync module 430A receives the request from Ftlink 450 and stores the request in FIFO 530. Compare logic 570 in Ftsync module 430A compares the requests from FIFO 520 (from CPU 410A) and FIFO 530 (from CPU 410B). Address, data, and time are compared. Compare logic 570 signals an error when the addresses, the data, or the local request times differ, or when a request arrives from only one CPU. A request from one CPU is detected with a timeout value. When the current time 591 is greater than the FIFO time (time from FIFO 520 or FIFO 530) plus a time offset 592, and only one FIFO has supplied data, a timeout error exists.

When both CPU 410A and CPU 410B are functioning properly, Ftsync module 430A forwards the request to host adaptor 440A. A similar path sequence can be created for access to host adaptor 440B.

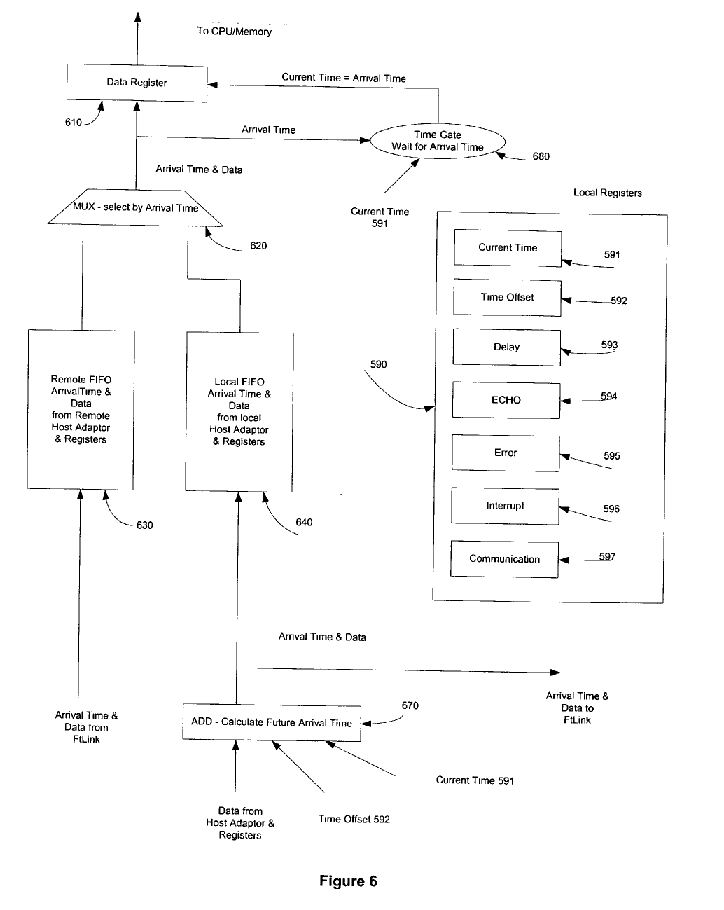

FIG. 6 illustrates actions that occur upon arrival of data at CPU 410A and CPU 410B. Data arrives from network interconnect 490 at one of host adaptors 440A and 440B. For this discussion, arrival at host adaptor 440A is assumed. The data from connection 460A is delivered to host adaptor 440A. An adder 670 supplements data from host adaptor 440A with an arrival time calculated from the current time 591 and a time offset 592, and stores the result in local FIFO 640. This data and arrival time combination is also sent across Ftlink 450 to Ftsync module 430B. A MUX 620 selects the earliest arrival time from remote FIFO 630 (containing data and arrival time from host adaptor 440B) and local FIFO 640 (containing data and arrival time from host adaptor 440A). Time gate 680 holds off the data from the MUX 620 until the current time 591 matches or exceeds the desired arrival time. The data from the MUX 620 is latched into a data register 610 and presented to CPU 410A and memory 420A. The data originally from host adaptor 440A and now in data register 610 of FtSync module 430A is delivered to CPU 410A or memory 420A based on the desired arrival time calculated by the adder 670 of Ftsync module 430A relative to the clock 475A of the CPU 410A. The same operations occur at the remote CPU.

Each CPU 410A and 410B is running off of its own clock structure 475A or 475B. The time offset 592 is an approximation of the time distance between the CPU modules. If both CPU modules were running off of a common clock system, either a single oscillator or a phase-locked structure, then the time offset 592 would be an exact, unvarying number of clock cycles. Since the CPU modules are using independent oscillators, the time offset 592 is an upper bound representing how far the clocks 475A and 475B can drift apart before the system stops working. There are two components to the time offset 592. One part is the delay associated with the fixed number of clock cycles required to send data from Ftsync module 430A to Ftsync module 430B. This is based on the physical distance between modules 430A and 430B, on any uncertainties arising from clock synchronization, and on the width and speed of the Ftlink 450. A ten-foot Ftlink using 64-bit, parallel cable will have a different delay time than a 1000-foot Ftlink using a 1-gigabit serial cable. The second component of the time offset is the margin of error that is added to allow the clocks to drift between re-calibration intervals.

Calibration is a three-step process. Step one is to determine the fixed distance between CPU modules 110A and 110B. This step is performed prior to a master/slave synchronization operation. The second calibration step is to align the instruction streams executing on both CPUs 410A and 410B with the current time 591 in both Ftsync module 430A and Ftsync module 430B. This step occurs as part of the transition from master/slave mode to duplex mode. The third step is recalibration and occurs every few minutes to remove the clock drift between the CPU modules.

Referring again to FIGS. 4 and 5, the fixed distance between the two CPU modules is measured by echoing a message from the master Ftsync module (e.g., module 430A) off of the slave Ftsync module (e.g., module 430B). CPU 410A sends an echo request to local register 590 in Ftsync module 430B. The echo request clears the current time 591 in Ftsync module 430A. When Ftsync module 430B receives the echo request, an echo response is sent back to Ftsync module 430A. Ftsync module 430A stores the value of its current time 591 into a local echo register 594. The value saved is the round trip delay or twice the delay from Ftsync module 430A to Ftsync module 410B plus a fixed number of clock cycles representing the hardware overhead in Ftsync communications. CPU 410A reads the echo register 594, removes the overhead, divides the remainder by two, and writes this value to the delay register 593. The time offset register 592 is then set to the delay value plus the drift that will be allowed between CPU clock systems. The time offset 592 is a balance between the drift rate of the clock structures and the frequency of recalibration. The time offset 592 will be described in more detail later. CPU 410A, being the master, writes the same delay 593 and time offset 592 values to the slave Ftsync module 430B.

At the termination of the memory copy described above for master/slave synchronization, the clocks and instruction streams of the two CPUs 410A and 410B must be brought into alignment. CPU 410A issues a sync request simultaneously to the local registers 590 of both Ftsync module 430A and Ftsync module 430B and then executes a halt. Ftsync module 430A waits delay 593 clock ticks before honoring the sync request. After delay 593 clock ticks, the current time 591 is cleared to zero and an interrupt 596 is posted to CPU 410A. Ftsync module 430B executes the sync request as soon as it is received. Current time 591 is cleared to zero and an interrupt 596 is posted to CPU 410B. Both CPU 410A and CPU 410B begin their interrupt processing from the same code stream in their respective one of memories 420A and 420B within a few clock ticks of each other. The only deviation will be due to uncertainty in clock synchronizers that are in the Ftlink 450.

The recalibration step is necessary to remove the clock drift that will occur between clocks 475A and 475B. Since the source oscillators are unique, the clocks will drift apart. The more stable and closely matched the two clock systems are, the less frequently the required recalibration. The recalibration process requires cooperation of both CPU 410A and CPU 410B since this is occurring in duplex operation. Both CPU 410A and CPU 410B request recalibration interrupts, which are sent simultaneously to Ftsync modules 430A and 430B, and then halt. Relative to their clocks 475A and 475B (i.e., current time 591), both CPUs have requested the recalibration at the same time. Relative to actual time, the requests occur up to time offset 592 minus delay 593 clock ticks apart. To remove the clock drift, each of Ftsync modules 430A and 430B waits for both recalibration requests to occur. Specifically, Ftsync module 430A freezes its current time 591 on receipt of the recalibration request from CPU 410A and then waits an additional number of clock ticks corresponding to delay 593. Ftsync module 430A also waits for the recalibration request from CPU 410B. The last of these two events to occur determines when the recalibration interrupt is posted to CPU 410A. Ftsync module 430B performs the mirror image process, freezing current time 591 on the CPU 410B request, waiting an additional number of clock ticks corresponding to delay 593, and waiting for the request from CPU 410A before posting the interrupt. On posting of the interrupt, the current time 591 resumes counting. Both CPU 410A and CPU 410B process the interrupt on the same local version of current time 591. The clock drift between the two clocks 475A and 475B has been reduced to the uncertainty in the synchronizer of the Ftlink 450.

Recalibration can be performed periodically or can be automatically initiated based on a measured drift. Periodic recalibration is easily scheduled in software based on the worst-case oscillator drift.

As an alternative, automatic recalibration can be created. Referring again to FIGS. 4 and 5, when requests are placed in remote FIFO 530, the entry consists of both data and the current time as seen by the other system. That is, Ftsync module 430A appends its version of current time 591 onto the request. When Ftsync module 430B receives the request, it does a recalibration check 580 of the current time from Ftsync module 430A and the current time 591 in Ftsync module 430B versus the time offset 592. When the time difference approaches time offset 592, then a recalibration should be performed to prevent timeout errors from being detected by compare 570. Since the automatic recalibration detection is occurring independently in each Ftsync module, this needs to be reported to both Ftsync modules 430A and 430B before the event can happen. To do this, a recalibration warning interrupt is posted from the detecting Ftsync module to both Ftsync 430A and 430B. The timing of the interrupt is controlled in FIG. 6 by the local registers 590 applying a future arrival time through the adder 670. Both CPU 410A and CPU 410B respond to this interrupt by initiating the recalibration step described above.

Automatic recalibration allows the interval between recalibrations to be maximized, thus saving system performance. The distance between recalibration can be increased by using larger values of time offset 592. This has the side effect of slowing the response time of host adaptors 440A and 440B because the time offset 592 is a component of the future arrival time inserted by the adder 670. As time offset 592 gets larger, so does the I/O response time. Making host adaptors 440A and 440B more intelligent can mitigate this effect. Rather than doing individual register accesses to the host adaptors, performance can be greatly enhanced by using techniques such as I²O (Intelligent I/O).

The Ftsync modules 430A and 430B are an integral part of the fault-tolerant architecture that allows CPU with asynchronous clock structures 475A and 475B to communicate with industry-standard asynchronous networks. Since the data is not buffered on a message basis, these industry-standard networks are not restricted from using remote DMA or large message sizes.

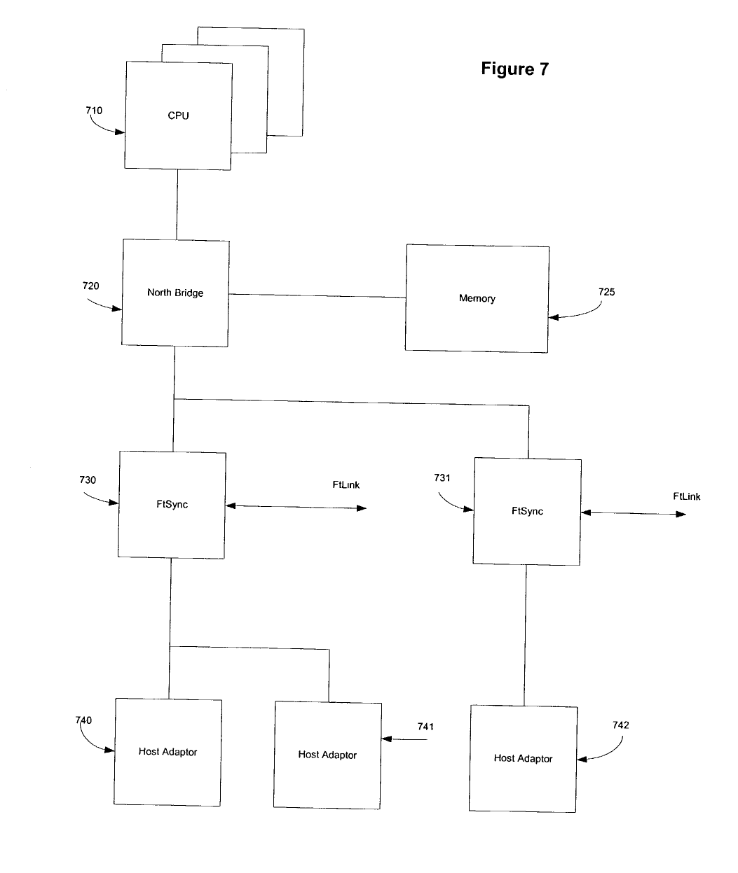

FIG. 7 shows an alternate construction of a CPU module 700. Multiple CPUs 710 are connected to a North bridge chip 720. The North bridge chip 720 provides the interface to memory 725 as well as a bridge to the I/O busses on the CPU module. Multiple Ftsync modules 730 and 731 are shown. Each Ftsync module can be associated with one or more host adaptors (e.g., Ftsync module 730 is shown as being associated with host adaptors 740 and 741 while Ftsync module 731 is shown as being associated with host adaptor 742). Each Ftsync module has a Ftlink attachment to a similar Ftsync module on another CPU module 700. The essential requirement is that all I/O devices accessed while in duplex mode must be controlled by Ftsync logic. The Ftsync logic can be independent, integrated into the host adaptor, or integrated into one or more of the bridge chips on a CPU module.

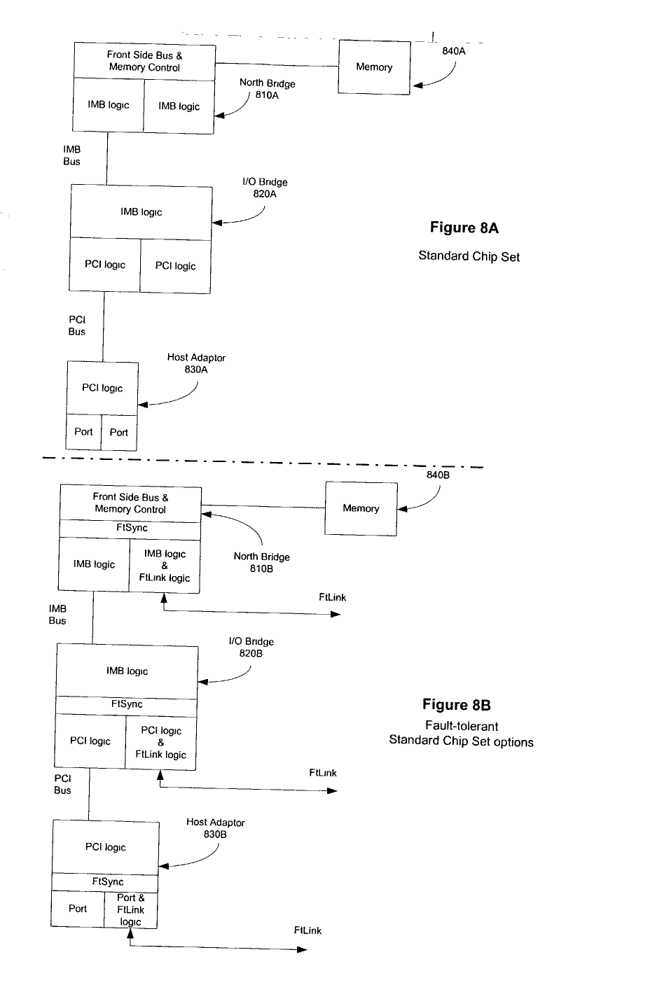

The Ftlink can be implemented with a number of different techniques and technologies. In essence, Ftlink is a bus between two Ftsync modules. For convenience of integration, Ftlink can be created from modifications to existing bus structures used in current motherboard chip sets. Referring to FIG. 8A, a chip set produced by ServerWorks communicates between a North bridge chip 810A and I/O bridge chips 820A with an Inter Module Bus (IMB). The I/O bridge chip 820A connects the IMB with multiple PCI buses, each of which may have one or more host adaptors 830A. The host adaptors 830A may contain a PCI interface and one or more ports for communicating with networks, such as, for example Ethernet or InfiniBand networks.

As described above, I/O devices can be connected into a fault-tolerant system with the addition of an FtSync module. FIG. 8B shows several possible places at which fault-tolerance can be integrated into standard chips without impacting the pin count of the device and without disturbing the normal functionality of a standard system. An FtSync module is added to the device in the path between the bus interfaces. In the North bridge chip 810B, the FtSync module is between the front side bus interface and the IMB interface. One of the IMB interface blocks is being used as a FtLink. When the North bridge chip 810B is powered on, the FtSync module and FtLink are disabled, and the North bridge chip 810B behaves exactly as the North bridge chip 810A. When the North bridge chip 810B is built into a fault-tolerant system, software enables the FtSync module and FtLink. Similar design modifications may be made to the I/O Bridge 820B or to an InfiniBand host adaptor 830B.

When the Ftsync logic is set up to be non-functional after a reset, a standard chip set may be created with a Ftsync module embedded. Only when the Ftsync module is enabled by software does it affect the functionality of the system. In this way, a custom fault-tolerant chip set is not needed, allowing a much lower volume fault-tolerant design to gain the cost benefits of the higher volume markets. The fault-tolerant features are dormant in the industry-standard chip set for an insignificant increase in gate count.

This architecture can be extended to triple modular redundancy, TMR. TMR involves three CPU modules instead of two. Each Ftsync logic block needs to be expanded to accommodate with one local and two remote streams of data. There will be either two Ftlink connections into the Ftsync module or a shared Ftlink bus may be defined and employed. Compare functions are employed in determining which of the three data streams and clock systems is in error.

This architecture can also be extended to providing N+1 sparing. Connecting the Ftlinks into a switch, any pair of CPU modules can be designated as a fault-tolerant pair. On the failure of a CPU module, any other CPU module in the switch configuration can be used as the redundant CPU module.

Any network connection can be used as the Ftlink if the delay and time offset values used in the Ftsync are selected to reflect the network delays that are being experienced so as to avoid frequent compare errors due to time skew. The more the network is susceptible to traffic delays, the lower the system performance will be.

Other implementations are within the scope of the following claims.

What is claimed is:

1. A method of synchronizing operation of two asynchronous processors with an I/O device, the method comprising:
receiving, at a first processor having a first clocking system, data from an I/O device, the data being received at a first time associated with the first clocking system;
forwarding the received data from the first processor to a second processor having a second clocking system that is not synchronized with the first clocking system;
processing the received data at the first processor at a second time corresponding to the first time in the first clocking system plus a time offset; and
processing the received data at the second processor at a third time corresponding to the first time in the second clocking system plus the time offset.

2. The method of claim 1 further comprising:
at the first processor, storing the received data during a period between the first time and the second time; and
at the second processor, storing the data forwarded by the first processor between a time at which the forwarded data is received and the third time.

3. The method of claim 2 wherein storing the received data at the first processor comprises storing the received data in a first FIFO associated with the first processor and storing the forwarded data at the second processor comprises storing the forwarded data in a second FIFO associated with the second processor.

4. The method of claim 1 wherein forwarding the received data comprises using a direct link between the first processor and the second processor.

5. The method of claim 4 wherein the time offset corresponds to a time required for transmission of data from the first processor to the second processor using the direct link plus a permitted difference in clocks of the first clocking system and the second clocking system.

6. The method of claim 1 wherein the I/O device includes a third clocking system that is not synchronized with the first clocking system or the second clocking system.

7. The method of claim 1 wherein the I/O device comprises an industry-standard I/O device.

8. The method of claim 7 wherein the first processor is connected to the I/O device by an industry-standard network interconnect.

9. The method of claim 8 wherein the industry-standard interconnect comprises Ethernet.

10. The method of claim 8 wherein the industry-standard interconnect comprises InfiniBand.

11. The method of claim 1 further comprising sharing the I/O device with another system that does not include the first processor or the second processor.

12. The method of claim 11 wherein the other system comprises a fault-tolerant system.

13. The method of claim 11 further comprising sharing at least a portion of the connection between the first processor and the I/O device with another system that does not include the first processor or the second processor.

14. The method of claim 13 wherein the other system comprises a fault-tolerant system.

15. A computer system comprising:
a first processor having a first clocking system, the first processor being connected to a network; and
a second processor connected to the network and having a second clocking system that is not synchronized with the first clocking system;
wherein:
the first processor is configured to:
receive data from an I/O device at a first time associated with the first clocking system,
forward the received data from the first processor to the second processor, and
process the received data at a second time corresponding to the first time in the first clocking system plus a time offset; and
the second processor is configured to process the received data at a third time corresponding to the first time in the second clocking system plus the time offset.

16. The system of claim 15 wherein:
the first processor is configured to store the received data during a period between the first time and the second time; and
the second processor is configured to store the data forwarded by the first processor between a time at which the forwarded data is received and the third time.

17. The system of claim 16 wherein the first processor includes a first FIFO in which the received data is stored and the second processor includes a second FIFO in which the forwarded data is stored.

18. The system of claim 15 further comprising a direct link between the first processor and the second processor, wherein the first processor is configured to forward the received data to the second processor using the direct link.

19. The system of claim 18 wherein the time offset corresponds to a time required for transmission of data from the first processor to the second processor using the direct link plus a permitted difference in clocks of the first clocking system and the second clocking system.

20. The system of claim 15 wherein the I/O device includes a third clocking system that is not synchronized with the first clocking system or the second clocking system.

21. The system of claim 15 wherein the I/O device comprises an industry-standard I/O device.

22. The system of claim 21 wherein the first processor is connected to the I/O device by an industry-standard network interconnect.

23. The system of claim 22 wherein the industry-standard interconnect comprises Ethernet.

24. The system of claim 22 wherein the industry-standard interconnect comprises InfiniBand.

25. The system of claim 15 wherein the I/O device is shared with another system that does not include the first processor or the second processor.

26. The system of claim 25 wherein the other system comprises a fault-tolerant system.

27. The system of claim 25 wherein at least a portion of the connection between the first processor and the I/O device is shared with another system that does not include the first processor or the second processor.

28. The system of claim 27 wherein the other system comprises a fault-tolerant system.
